(19) United States
(12) Patent Application Publication
(10) Pub. No.: US 2018/0160711 A1
(43) Pub. Date: Jun. 14, 2018

(54) Food and Liquid Compositions for Human Consumption Containing Flower Pollen

(71) Applicant: RAES Foods, Inc. d/b/a Bee Free Honee, Minneapolis, MN (US)

(72) Inventor: Kathlyn N. Sanchez, Plymouth, MN (US)

(21) Appl. No.: 15/376,462

(22) Filed: Dec. 12, 2016

(51) Int. Cl. A23L 33/105; A23L 2/52; A23L 19/00

(52) U.S. Cl. CPC A23L 33/105; A23V 2002/00; A23L 19/00; A23L 2/52

(57) ABSTRACT

Flower pollen may be added to one or more types of food or liquid compositions for human consumption. The one or more types of food or liquid compositions for human consumption may include, but are not limited to, honey substitutes, plant-based waters, and plant-based foods. The flower pollen may be pharmaceutical-grade, allergen-free, Pareve and Kosher-certified.

### FIELD OF THE DISCLOSURE

The present disclosure generally relates to food and liquid compositions for human consumption, and more particularly to food and liquid compositions for human consumption containing flower pollen.

### BACKGROUND

Bee pollen has been touted for use as a health supplement. However, when it is collected from bees, the nutrients associated with bee pollen can vary from batch to batch depending on factors such as time and location where collected, with no two samples of bee pollen being exactly identical. Further, those with pollen allergies may not be able to use bee pollen for health purposes.

### SUMMARY

Embodiments of the present disclosure may provide a food composition incorporating flower pollen, wherein the flower pollen may be pharmaceutical-grade, allergen-free, Pareve and Kosher-certified. The food composition may be a plant-based honey substitute having approximately 79-81 brix and a pH below 4.0. The plant-based honey substitute may be comprised of fruit juice/fruit juice concentrate, at least one acid, and sugar. The flower pollen may be introduced into the plant-based honey substitute after it has been cooked but before it cools completely, and no additional heat may be applied. The food composition may be a plant-based food. The flower pollen may be introduced into dry ingredients forming the plant-based food. The flower pollen may be a lipid-soluble portion of rye grass flower pollen extract in paste form, or the flower pollen is a water-soluble portion of rye grass flower pollen extract. The flower pollen incorporated in the food composition may be in a raw form or in a powder form.

Other embodiments of the present disclosure may provide a plant-based water incorporating flower pollen, wherein the flower pollen may be pharmaceutical-grade, allergen-free, Pareve and Kosher-certified. The flower pollen may be mixed with the plant-based water under agitation at a temperature under approximately 200 degrees F. The plant-based water incorporating flower pollen may be housed in a container protecting the plant-based water from exposure to direct light. The plant-based water may be selected from the group including, but not limited to, coconut water, melon water, birch water, maple water, cactus water, herb water, leaf water, and tree water.

Further embodiments of the present disclosure may provide a plant-based food incorporating flower pollen, wherein the flower pollen may be pharmaceutical-grade, allergen-free, Pareve and Kosher-certified. The flower pollen may be introduced into dry ingredients comprising the plant-based food to form a dry mixture, the dry mixture may be mixed with wet ingredients comprising the plant-based food to a form a wet mixture, and the wet mixture may sit for approximately one hour to allow for absorption. The wet mixture may be formed in scoops or smoothed out flat and baked at a temperature at or less than approximately 300 degrees Fahrenheit. The wet mixture may not be baked and may be formed as a raw bar. The flower pollen may be in powder form and the plant-based food may be dehydrated. The plant-based food may be used as one or more of the following: military meals-ready-to-eat (MREs), camping foods, and foods for use during space exploration.

### DETAILED DESCRIPTION

Embodiments of the present disclosure may provide for the addition of flower pollen to one or more types of food or liquid compositions for human consumption. The one or more types of food or liquid compositions for human consumption may include, but are not limited to, honey substitutes, plant-based waters, and plant-based foods.

Flower pollen used according to embodiments of the present disclosure may be a pharmaceutical-grade functional food that is Kosher as well as Pareve, and it may be harvested in a manner that allows it to be allergen-free. Inclusion of flower pollen in food or liquid compositions for human consumption may provide all of the nutrients that a human may require for survival when blended together. While flower pollen may be incorporated to provide nutritional value, it should be appreciated that inclusion of flower pollen may provide for compliments to women's health, men's health, prostate health, urinary function, immune system health and/or menopausal support without departing from the present disclosure.

One or more types of flower pollen may be utilized according to embodiments of the present disclosure. In an embodiment of the present disclosure, a paste form of lipid-soluble portion of rye grass flower pollen extract may be used. Such a paste may provide a high level of antioxidants according to the ORAC test. In another embodiment of the present disclosure, a water-soluble portion of rye grass pollen extract may be used. This type of flower pollen may provide each of the common amino acids along with all 10 essential amino acids, and it also may provide high levels of antioxidant nutrients according to the ORAC test. Further, this type may be non-allergenic. As it is water-soluble, this may provide for easier blending into food or liquid compositions for human consumption. While certain types of flower pollens have been described herein, it should be appreciated that other flower pollens may be utilized without departing from the present disclosure. However, these flower pollens should be free from allergens as well as being Kosher and Pareve certified and pharmaceutical grade.

Flower pollen used according to embodiments of the present disclosure may be in raw form or in a powder form. It also should be appreciated that the flower pollen may blended with food or liquid compositions for human consumption in different manners without departing from the present disclosure. Further, different amounts of flower pollen may be introduced into food or liquid compositions for human consumption according to embodiments of the present disclosure. The amounts introduced may be dependent on the degree of nutrients to be provided per serving of the food or liquid compositions for human consumption.

In some embodiments of the present disclosure, flower pollen may be blended with a honey substitute. Honey substitutes may be desirable for those who suffer from allergies to honey, young children, vegans, as well as those with compromised immune systems who are unable to consume raw honey. When the term “honey substitute” is used, this may refer to a plant-based, sustainable honey substitute made from fruit juice/fruit juice concentrate, one or more acids, and sugar. The one or more acids may include, but are not limited to, lemon juice and citric acid. The fruit juice/fruit juice concentrate may be apple juice, apple juice concentrate, or any other fruit juice or fruit juice concentrate. In an embodiment of the present disclosure, a honey substitute may be formed from certified organic apples, lemon juice and cane sugar. The components forming a honey substitute may be blended and cooked until reaching between approximately 79-81 brix, and the honey substitute formed may be a food product that tastes similar to traditional honey harvested from bees. Once the honey substitute has been cooked but before it cools, flower pollen may be added with agitation to incorporate the flower pollen fully. No additional heat is applied when the flower pollen is added so as to maintain the nutritional value of the honey substitute as well as the flower pollen. It also should be appreciated that the flower pollen should be introduced into the honey substitute prior to bottling, insofar as bottling can be a hot-fill process.

Upon incorporation of the flower pollen into the honey substitute, a final product may be formed that is approximately 79-81 brix—like traditional honey—and with a pH of below 4.0—also like traditional honey. As the flower pollen utilized according to embodiments of the present disclosure is allergen-free, pharmaceutical-grade, Kosher-certified, and measured out as a lab-tested ingredient, this allows for control of the amount of nutrients per serving. Thus, a consistent product having a reliable nutritional label may be provided. This is a departure from traditional honey containing pollen in that traditional honey suppliers cannot/do not test each batch of traditional honey to determine what nutrients are contained within the batch or the level of nutrients contained within the pollen gathered for that particular honey harvest. Accordingly, a honey substitute containing flower pollen according to embodiments of the present disclosure may provide a consistent product in texture, color, and baking and cooking measurements, while also being superior in nutritional value as well as in quality.

In other embodiments of the present disclosure, flower pollen may be introduced into plant-based water. Plant-based water may include, but is not limited to, coconut water, melon water, birch water, maple water, cactus water, herb water, leaf water, and tree water. Flower pollen may be mixed, under agitation, with a plant-based water at a temperature under approximately 200 degrees Fahrenheit. The resulting product may provide every element for survival of the human body in a single product. It should be appreciated that the resulting product formed according to embodiments of the present disclosure may be housed in a container that may protect it from exposure to direct light in order to maintain the integrity of the nutrients contained within the plant-based water containing flower pollen.

In further embodiments of the present disclosure, flower pollen may be incorporated into plant-based foods. Plant-based foods may include, but are not limited to, pulses, seeds, nuts, as well as other foods that may be dried, dehydrated, raw and/or have a low temperature/short baking time. In order to formulate a plant-based food containing flower pollen, the flower pollen may be introduced into the dry ingredients that comprise the plant-based food. Then, the dry ingredients including the flower pollen may be mixed in with the wet ingredients used to form the plant-based food. In embodiments of the present disclosure, once the dry ingredients have been mixed with the wet ingredients, the resultant mixture may sit for approximately one hour to allow the pulses to absorb. The pulses may be ground to a chunky-like flour in order to enable faster absorption. After the mixture has sat for approximately one hour, the mixture may be formed in scoops or smoothed out flat and baked at a temperature at or less than approximately 300 degrees Fahrenheit until the plant-based food containing flower pollen has completely baked. In some embodiments of the present disclosure, the resultant plant-based food containing flower pollen may be dehydrated. In other embodiments of the present disclosure, the mixture may not be baked and may be formed as a raw bar. It should be appreciated that similar methods may be utilized to create seed and/or grain bars containing flower pollen according to embodiments of the present disclosure. In some embodiments of the present disclosure, flower pollen may be provided in a powder form and introduced into dehydrated foods, such as for use as part of military meals-ready-to-eat (MREs), camping foods, and foods for use during space exploration. In other embodiments of the present disclosure, flower pollen in powder form may be mixed into raw nutrition bars, such as seed or nut bars. Through addition of flower pollen to plant-based foods, such as pulses, foods that may be dried, dehydrated, raw and/or have a low temperature/short baking time, foods may be provided that offer complete nutrition in a shelf-stable format.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A food composition incorporating flower pollen, wherein the flower pollen is pharmaceutical-grade, allergen-free, Pareve and Kosher-certified.

2. The food composition of claim 1, wherein the food composition is a plant-based honey substitute having approximately 79-81 brix and a pH below 4.0.

3. The food composition of claim 2, wherein the plant-based honey substitute is comprised of fruit juice/fruit juice concentrate, at least one acid, and sugar.

4. The food composition of claim 2, wherein the flower pollen is introduced into the plant-based honey substitute after it has been cooked but before it cools completely, and no additional heat is applied.

5. The food composition of claim 1, wherein the food composition is a plant-based food.

6. The food composition of claim 5, wherein the flower pollen is introduced into dry ingredients forming the plant-based food.

7. The food composition of claim 1, wherein the flower pollen is a lipid-soluble portion of rye grass flower pollen extract in paste form.

8. The food composition of claim 1, wherein the flower pollen is a water-soluble portion of rye grass flower pollen extract.

9. The food composition of claim 1, wherein flower pollen incorporated in the food composition is in a raw form.

10. The food composition of claim 1, wherein flower pollen incorporated in the food composition is in a powder form.

11. A plant-based water incorporating flower pollen, wherein the flower pollen is pharmaceutical-grade, allergen-free, Pareve and Kosher-certified.

12. The plant-based water of claim 11, wherein the flower pollen is mixed with the plant-based water under agitation at a temperature under approximately 200 degrees Fahrenheit.

13. The plant-based water of claim 11, wherein the plant-based water incorporating flower pollen is housed in a container protecting the plant-based water from exposure to direct light.

14. The plant-based water of claim 11, wherein the plant-based water is selected from the group comprising:
coconut water, melon water, birch water, maple water, cactus water, herb water, leaf water, and tree water.

15. A plant-based food incorporating flower pollen, wherein the flower pollen is pharmaceutical-grade, allergen-free, Pareve and Kosher-certified.

16. The plant-based food of claim 15, wherein the flower pollen is introduced into dry ingredients comprising the plant-based food to form a dry mixture, the dry mixture is mixed with wet ingredients comprising the plant-based food to a form a wet mixture, and the wet mixture sits for approximately one hour to allow for absorption.

17. The plant-based food of claim 16, wherein the wet mixture is formed in scoops or smoothed out flat and baked at a temperature at or less than approximately 300 degrees Fahrenheit.

18. The plant-based food of claim 16, wherein the wet mixture is not baked and is formed as a raw bar.

19. The plant-based food of claim 15, wherein the flower pollen is in powder form and the plant-based food is dehydrated.

20. The plant-based food of claim 19, wherein the plant-based food is used as one or more of the following:
military meals-ready-to-eat (MREs), camping foods, and foods for use during space exploration.
